(19) United States
(12) Patent Application Publication
(10) Pub. No.: US 2023/0260035 A1
(43) Pub. Date: Aug. 17, 2023

(54) SYSTEM AND METHOD FOR ANALYZING, EVALUATING AND RANKING PROPERTIES USING ARTIFICIAL INTELLIGENCE

(71) Applicant: ReAlpha Tech Corp, Dublin, OH (US)

(72) Inventors: Giri Devanur, Dublin, OH (US); Monaz Hormuzd Karkaria, Frisco, TX (US)

(73) Assignee: ReAlpha Tech Corp, Dublin, OH (US)

(21) Appl. No.: 17/944,255

(22) Filed: Sep. 14, 2022

Related U.S. Application Data
(60) Provisional application No. 63/244,222, filed on Sep. 14, 2021.

(51) Int. Cl. G06Q 40/06; G06Q 50/16; G06Q 30/02

(52) U.S. Cl. CPC G06Q 40/06; G06Q 30/0206; G06Q 50/16

(57) ABSTRACT

The embodiments herein provide a system and method to analyse properties at a scale on more than 25 distinct factors and assign them a score from 0-100 showing to identify a strong investment on a selected property using artificial intelligence model. The system collects the data various third-party systems by means of API connection, web scraping, store the data and provides the final investment ranking score using the data collected using an AI model that. A primary filter removes the properties that do not meet preliminary criteria from the acquisition pipeline. A web-based application complements the AI model’s scoring by allowing human analysts to evaluate and score the property. The scores provided by the analysts are stored for retraining the AI model. The final investment ranking score is a weighted sum of proximity score, market score and financial score.

### BACKGROUND

### Technical Field

The embodiments herein are generally related to field of real estates and investment. The embodiments herein are particularly related to a system and method for analysing properties with respect to investment. The embodiments herein are more particularly related to a system and method for analysing, evaluating and ranking properties using artificial intelligence.

### Description of Related Art

Real estate markets in most countries are not as organized or efficient as markets for other, more liquid investment instruments. Individual properties are unique to themselves and not directly interchangeable, which makes evaluating investments less certain. Unlike other investments, real estate is fixed in a specific location and derives much of its value from that location. Industrial real estate with residential real estate, the perceived safety of a neighbourhood and the number of services or amenities nearby can increase the value of a property. For this reason, the economic and social situation in an area is often a major factor in determining the value of its real estate.

Property valuation is often the preliminary step taken during a real estate investment. Information asymmetry is commonplace in real estate markets, where one party may have more accurate information regarding the actual value of the property. Real estate investors typically use a variety of real estate appraisal techniques to determine the value of properties prior to purchase. This typically includes gathering documents and information about the property, inspecting the physical property, and comparing it to the market value of comparable properties. A common method of valuing real estate involves dividing its net operating income by its capitalization rate, or CAP rate.

Numerous national and international real estate appraisal associations exist for the purpose of standardizing property valuation. Investment properties are often purchased from a variety of sources, including market listings, real estate agents or brokers, banks, government entities such as public auctions, sales by owners, and real estate investment trusts.

Having contrasting investment ideologies and ethos, the investors differ in terms of what features they take into account to judge a property. Some may rate a property high while others may deem the same unworthy of investment. Although they differ in their mindsets and perspectives, they converge on the fact that they expect a good share of return for their investment. So, before investing they estimate the return they get for their investment. To estimate the return, they use the following things: a). Past data and statistics; b) Attractions and nearby places; and c) Socio-environmental aspects.

The best way to predict the future is to study the past by collecting and analysing the past data and statistics. Although markets are seldom deterministic, it is highly unlikely that the market statistics will change unless situations are in an extreme state of flux. Investors, thus at first try to find the statistics (both short-term rentals and property appreciation) for equivalent properties in a vicinity. Using these data, they try to figure out the revenue that would be made by the property in the coming years. If they deem the return good enough, the property passes the first test which is the test based on past data.

In the attractions and nearby places field, people look into nearby restaurants, attractions, downtowns, airports, and other things to figure out if a given market will turn into a “must visit” one, although they were not in the past.

In the Socio-environmental aspects, people consider aspects like the unemployment rate, crime rate, quality of life, temperature, and so forth to predict if a given market will boom based on these patterns.

While the tools and the features of properties used to gauge their goodness of investment may be divided into different groups, they fall under the above three categories almost exclusively.

So, there is a requirement of investors to identify, analyse and rank a selected property with respect to investment and to understand how strong the investment in the property is.

Hence there is a need for a system and method to analyse properties at a scale on a plurality of (more than 25) mutually different factors and assign them a score from 0-100 showing to identify a strong investment on a selected property.

The abovementioned shortcomings, disadvantages and problems are addressed herein, which will be understood by reading and studying the following specification.

### OBJECTIVES OF THE EMBODIMENTS HEREIN

The primary object of the embodiments herein is to develop a system and method to analyse a plurality of properties at a scale on more than 25 mutually different factors and assign them a score from 0-100 to identify a strong investment on a selected property using artificial intelligence model.

Another object of the embodiments herein is to develop a system and method for generating AI model for providing a ranking on the plurality of properties under evaluation using the data collected.

Yet another object of the embodiments herein is to develop a system and method for collecting the data from various third-party systems by means of API connection, web scraping.

Yet another object of the embodiments herein is to develop a system and method to provide a primary filter for removing the properties that do not meet a preliminary criterion such as legal, crime rating and liveability, etc., from the acquisition pipeline.

Yet another object of the embodiments herein is to develop a system and method to provide a web platform called HUMINT platform, which is a web-based application that complements the AI model’s scoring by allowing human analysts to evaluate and score the property.

Yet another object of the embodiments herein is to develop a system and method to store and use the scores provided by the analysts in retraining the AI model.

Yet another object of the embodiments herein is to develop a system and method for providing a ranking on properties using financial, proximity and market analysis.

Yet another object of the embodiments herein is to develop a system and method to conduct a cohort analysis to find short term rentals similar to the property under consideration using filtering criteria that include location-based parameter or data or features (such as address, zip code, latitude and longitude coordinates) and physical features (property type, bedrooms, bathrooms, max guests, amenities).

Yet another object of the embodiments herein is to develop a system and method to perform time-series analysis in these resulting comps data and use it to develop a model to estimate monthly ADR, occupancy rates, revenue, and reservation days of the property under consideration for the future.

Yet another object of the embodiments herein is to develop a system and method to estimate a cap rate and to assign a financial score to the property based on the estimated cap rate.

Yet another object of the embodiments herein is to develop a system and method to estimate a proximity score and a market score to the property to indicate the strength of investing on the property.

Yet another object of the embodiments herein is to develop a system and method to estimate a proximity score based on factors like schools/colleges/universities, hospitals/clinics, gym/fitness centers, train stations/bus stations, Airports, Stores, restaurants, stadiums, downtowns/business centers, tourist attraction centers such as museums, churches, parks, theatres, and any other things that are tagged as tourist attractions.

Yet another object of the embodiments herein is to develop a system and method to estimate a Real Estate Market score based on factors like demography, employment, and other socio-environmental aspects like weather quality, comfort index, crime rates, etc.

Yet another object of the embodiments herein is to develop a system and method to estimate a final score which is simply a weighted sum of market score, proximity score and financial score.

Yet another object of the embodiments herein is to develop a system and method to estimate a final score which is simply a weighted sum of financial score, proximity score and market score.

Yet another object of the embodiments herein is to develop a system and method to estimate a proximity score comprising downtown score, restaurant score, airport score, attraction score, and store score.

Yet another object of the embodiments herein is to develop a system and method to estimate a market score comprising walk score, population density score, crime score, house appreciation score, job prospect score, weather score, air quality score, and water quality score.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system and method to analyse properties at a scale on more than 25 mutually different factors and assign them a score from 0-100 to identify a strong investment on a selected property using artificial intelligence model.

According to an embodiment herein, a system is provided to analyse properties at a scale on more than 25 mutually different factors and assign them a score from 0-100 to identify a strong investment on a selected property using artificial intelligence model. The system comprises components that collect the data, store the data and an AI model that provides the final investment ranking score using the data collected. The data is collected from various third-party systems by means of API connection, web scraping. A primary filter removes the properties that do not meet preliminary criteria such as legal, crime rating, liability, and liveability, etc., from the acquisition pipeline. The ranking score algorithm is an AI model that is responsible for providing the investment score for the property under evaluation. The web platform is a web-based application that complements the AI model’s scoring by allowing human analysts to evaluate and score the property. The scores provided by the analysts are stored to be later used in retraining the AI model.

According to an embodiment herein, the AI based ranking score algorithm is composed of Proximity Analysis, Market Analysis and Financial Analysis.

According to an embodiment herein, the AI based ranking score algorithm is executed to collect property features or data such as location features, physical features and investment features using a plurality of third-party systems by means of API connection, web scraping. The collected property data are subjected to Proximity Analysis Market Analysis and Financial Analysis to obtain a proximity score, a market score and a financial score to estimate final investment ranking score. The final investment ranking score is simply a weighted sum of proximity score, market score and financial score. Mathematically

$$\begin{matrix}\text{Brain Score = 0} \text{.25 * Market Score+ 0} \text{.25 * Proximity Score +} \\ \text{0} \text{.5 * Financial Score} \text{.}\end{matrix}$$

The proximity score comprises downtown score, restaurant score, airport score, attraction score, and store score. The market score comprises walk score, population density score, crime score, house appreciation score, job prospect score, weather score, air quality score, and water quality score. The final investment ranking score is simply a weighted sum of financial score, proximity score and market score. Mathematically

$$\begin{matrix}\text{Brain Score = 0} \text{.25 * proximity score + 0} \text{.25 * market score +} \\ \text{0} \text{.5 * Financial Score} \text{.}\end{matrix}$$

According to an embodiment herein, the proximity score is calculated using the equation:

$$\begin{matrix}p r o x i m i t y \_ s c o r e = 0.1 \times d o w n t o w n \_ s c o r e + 0.1 \times \\ r e s t a u r a n t \_ s c o r e + 0.3 \times a i r p o r t \_ s c o r e + \\ 0.1 \times s t o r e \_ s c o r e + 0.1 x a t t r a c t i o n \_ s c o r e .\end{matrix}$$

According to an embodiment herein, the market score is calculated mathematically as follows:

$$\begin{matrix}M a r k e t \_ s c o r e = 0.1 \times w a l k \_ s c o r e + 0.05 \times \\ p o p u l a t i o n \_ d e n s i t y \_ s c o r e + 0.1 \times \\ c r i m e \_ s c o r e + 0.2 \times \\ h o u s e \_ a p p r e c i a t i o n \_ s c o r e + 0.1 \times \\ j o b \_ p r o s p e c t \_ s c o r e + 0.1 \times \\ w e a t h e r \_ s c o r e + 0.05 \times \\ a i r \_ q u a l i t y \_ s c o r e + 0.05 \times \\ w a t e r \_ q u a l i t y \_ s c o r e .\end{matrix}$$

According to an embodiment herein, the location features or parameters or data of a property includes full address of the property, and wherein the address includes name of the city in which the property is located, state, Zip code, latitude, and longitude of the property.

According to an embodiment herein, the physical features or parameters or data includes a type of property, and amenities provided in the property. The amenities include maximum number of guests accommodated in the property, number of bathrooms and bedrooms provided in the property. A furnishing price of the property is calculated based on the number of bedrooms and number of bathrooms and its furnishing cost.

According to an embodiment herein, the full address data, zip code, the latitude and longitude coordinates, and the physical features or parameters or data are subjected to a cohort analysis to obtain an output. The output of the cohort analysis is subjected to time series analysis to compute an expected month-wise ADR and an expected month-wise reservation days to compute an expected yearly revenue for the property.

According to an embodiment herein, the investment related features of the property comprise listed price of the property on market, the number of days on market with the listed price, and the last known price on the market, and the current status of the property. A purchase price of the property is calculated based on the listed price of the property on market, the number of days on market with the listed price, and the last known price on the market. A property tax and the utility tax are calculated based on the computed purchase price of the property. A closing cost and the total utility cost are calculated based on the computed purchase value and computed furnishing cost.

According to an embodiment herein, a plurality of derived parameters is calculated based on the collected investment related parameters. The derived parameters include an insurance cost and the HOA fees for the property.

According to an embodiment herein, a property management cost, and a repair and maintenance cost are calculated based on the estimated expected yearly revenue of the property.

According to an embodiment herein, an operating expense for the property is calculated based on the computed property management cost, the computed repair and maintenance cost, the computed property tax, the computed utility tax, the computed insurance cost and the computed HOA fees for the property.

According to an embodiment herein, a net operating income is calculated based on the estimated expected yearly revenue of the property and the computed operating expenses of the property.

According to an embodiment herein, a cap rate for the property is calculated based on the computed net operating income and the total utility cost of the property. A financial score of the property is calculated based on the computed cap rate for the property.

According to an embodiment herein, the cohort analysis is performed on the collected location-based data/parameter/feature and the collected physical parameter data of the property under consideration. The collected location-based data and the collected physical parameter data of the property under consideration are filtered using a filtering module to find short term rentals of the property similar to the property under consideration. The location-based data includes address, zip code, latitude and longitude coordinates of the property under consideration. The physical parameter data of the property under consideration comprises property type, bedrooms, bathrooms, max guests, amenities provided in the property under consideration.

According to an embodiment herein, the priority of these parameters used for filtering includes Latitude and Longitude coordinates, Zip code, number of bedrooms, and number of bathrooms, maximum number of guests to be accommodated, and type of property, and amenities provided in the property for the property under consideration. The property under consideration is ignored and ranked of least interest or ranking, when the number of computations obtained based on the search criteria is less than 12. The number of filtering criteria is reduced until at least a dozen computations are obtained. A dozen computations are obtained when the number of filtering criteria is greater than 4. When the number of filtering criteria is equal to or less than 4, a search for the property in a broader vicinity is conducted.

After cohort analysis, at least a dozen properties with their monthly Revenue, ADR, occupancy rates, and reservation days are obtained. All these resulting comps data and the property under consideration have the same values for the features that form the filtering criteria. A time-series analysis is performed on these resulting computed data to develop an AI model to estimate monthly ADR, occupancy rates, revenue, and reservation days of the property under consideration for the future.

According to an embodiment herein, a cap rate for the property is calculated using the algorithm which is executed on a hardware processor in the system. The method of calculating the cap rate comprises the following steps given below.
a) Input property _tax_percentage, utility_percentage, closing_cost_percentage, property_management_percentage, repair_and_maintainance_percentage values
b) Calculate the annual value using the following mathematical equation:
$$\begin{matrix}\text{annual\_revenue =} \\ \text{sum of month-wise product of ADR and reservation days}\end{matrix}$$
c) Calculate the property tax using the following mathematical equation:
$$\begin{matrix}\text{property\_tax =property\_tax\_percentage/100 *} \\ \text{purchase\_price}\end{matrix}$$
d) Calculate the utility value using the following mathematical equation:
$$\text{utility = utility\_percentage/100} \text{*} \text{purchase\_price}$$
e) Calculate the property management cost using the following mathematical equation:
$$\begin{matrix}\text{property\_management =} \\ \text{property\_management\_percentage/100*annual\_revenue}\end{matrix}$$
f) Calculate the repair and maintenance cost of the property using the following mathematical equation:
$$\begin{matrix}\text{repair\_and\_maintainance} \text{=} \\ \text{repair\_and\_maintainance\_percentage} \text{/} \text{100} \text{*} \\ \text{annual\_revenue}\end{matrix}$$
g) Calculate the operating expenses cost of the property using the following mathematical equation:
$$\begin{matrix}\text{operating\_expenses} \text{=} \text{utility} \text{+} \text{property\_tax} \text{+} \text{insurance} \text{+} \\ \text{HOA} \text{fees} \text{+} \text{property\_management} + \\ \text{repair\_and\_maintaince}\end{matrix}$$
h) Calculate the net operating income of the property using the following mathematical equation:
$$\text{net\_operating\_income} \text{=} \text{annual\_revenue} \text{- operating\_expenses}$$
i) Calculate the closing cost of the property using the following mathematical equation:
$$\begin{matrix}\text{closing\_cost} \text{=} \text{closing\_cost\_percentage} \text{/} \text{100 *} \\ \left(\text{purchase\_price + furniture\_price}\right)\end{matrix}$$
j) Calculate the total utility value of the property using the following mathematical equation:
$$\text{total\_uses = purchase\_price + furniture\_price + closing\_cost}$$
k) Calculate the cap rate for the property using the following mathematical equation:
$$\text{cap\_rate = net\_operating\_income / total uses * 100}$$

According to an embodiment herein, a financial score for the property is assigned or calculated based on the computed cap rate value using an algorithm. The method for calculating the financial score using the algorithm comprised the following steps.

$$100 * \left(1 \text{- exp} \left(\text{-cap\_rate / 4} \text{.5}\right)\right)$$

According to one embodiment herein, the steps used in the filtering process to identify a list of suitable properties for analysis and investment are as follows: Different types of properties perform differently even in the same market. Properties with fewer guests (targeted to couples) perform well compared to properties with more accommodates (targeted to family) in the area renowned for honeymoons and dating (e.g., Maldives). When a property under evaluation (selected property) is not already listed on real estate market platform, the revenue of the nearby properties similar to the selected property is estimated under the assumption that the performance of the selected property performance does not differ by a large margin. Hence there is a need to find out properties comparable to the selected property. The steps followed are Filtering a property based on physical features; and filtering a property based on location;

According to an embodiment herein, the steps of filtering property based on physical features are as follows: when the selected property has x beds, y bedrooms, z bathrooms, and m guests_counts, then the properties that pass all the following criteria are forwarded to the next stage. The criteria for passing the properties to the next stages are:
a) The property must have beds count in between x-2 and x+2;
b) The property must have bedrooms_count in between y-1 and y+2;
c) The property must have bathrooms_count in between z-1 and z+1;
d) The property must have guests-count in between m-2 and m+2;
e) The limit of 2 is used for beds and guests as they have a higher variance compared to bedrooms and bathrooms.

According to an embodiment herein, the properties are filtered based on location parameters in a free market, a property competes with other comparable properties within its vicinity. According to an embodiment herein, the vicinity is defined by a circle of radius 1500 m with the selected property in the center. However, there are properties in sparse regions where none of the other properties within 1500 m survives the first stage filtering process. This creates a data scarcity problem. To counter this, two filtering processes are performed based on two criteria, so that the properties must pass at least one filtering process to move to the next stage. The two filtering processes are properties lying within 1500 m and a preset number of neighbourhood properties, and wherein the preset number is 20.

According to an embodiment herein, all the properties that survive the first stage filtering process and lying within 1500 m are passed to next step in the filtering process within 1500 m. Let Si be the set of properties.

According to an embodiment herein, a preset number of properties that survive the first stage filtering process and are in neighbourhood of each other are passed to next step in the neighbourhood filtering process. Let S₂ be the set of properties. These two processes ensure that at least 20 comps are selected. The set of properties that survive filtering by location is S₁ U S₂. K-nearest neighbors are also selected based on a radius-based selection process. Wherein the selection of radius depends on the location and features such as bed, bedrooms, bathrooms, guests. In most of the cases S₂ □ S₁.

According to an embodiment herein, for few cases where either the real estate market listings are sparse, or the property of consideration has an unusual combination of beds, bedrooms, bathrooms, and guests; then properties that pass through the first stage filtering process are fewer even in dense areas. For example, a property with 25 beds, 16 beds, 19 bathrooms, and 24 guests. In the above two cases, S₁ □ S₂.

According to an embodiment herein, in the cases where S₂ □ S₁., which is true mostly, the steps of filtering based on physical properties and the filtering process based on location are commutative, which indicates that the order of filtering does not play a significant role, or the order processing is not required. But the order of processing is significant or required when S₁ □ S₂.

According to an embodiment herein, two more filtering processes are conducted. They are Filtering by current price, and Filtering by amenities.

According to one embodiment herein, the process of filtering by current prices comprises checking the current nightly price and selecting the properties between a certain range (let us say between half of our price and double of our price)

According to one embodiment herein, the process of filtering by amenities involves using intersection of properties over Union of properties to find comps. Let us say our property has amenities A, B, C, D, and property in the vicinity has amenities B, D, E. There are 2 common amenities among us and 5 amenities in the union. So, the Amenities IoU score is ⅖ = 0.4. A filtering criterion is selected such that only those properties with more than 0.25, or other values, are selected. The search of identifying comps is thought of as a funnel where properties with disparities in terms of beds and bathrooms are shrugged off in the first instance, and distant properties are shrugged off in the second instance, and so forth.

The process of finding comps provides the properties that are comparable to selected properties along with their past statistics. An example of comps data is shown below

| PROPERTY | Bed, Bath, Lat, Amenities | ADR_JAN 2018 | ....... | ADR_JAN 2022 | REV_JAN-2018 | .......... | REV_JAN-2022 |
|---|---|---|---|---|---|---|---|
| P₁ | 2,3,3,9... | 278 | | 309 | 4321 | | 5676 |
| P₂ | 3,2,2,2... | | | | | | |
| ........ | ..... | | | | | | |
| P₃₈ | 4,2,3,3 | 389 | | 487 | 5212 | | 5223 |
| Median | | 312.3 | | 356 | 5434 | | 5232 |

According to an embodiment herein, the median revenue of the comps for each month ranging from January 2018 to January 2022 is calculated from the comps data. The median is column wise median rather than the revenue of a property that outperformed half of the comps and lagged off to the remaining half. A Prophet time-series model is trained to fit these past median revenues. The trained model is then used to estimate median revenues from February 2022 to January 2023 (12 months). Assuming that the selected property performs similar to a property in the 50th percentile, the revenue earned is similar to the estimated median revenues. The revenues for each month are summed to calculate the estimated annual revenue R. The Average Daily rate (ADR), and occupancy rate for the next 12 months are estimated. The data set in the real estate platform relies on this time series analysis to estimate annual revenue R.

According to an embodiment herein, the capitalization rate (cap rate) is the rate of return on a real estate investment property based on the income expected to be generated by the property. The estimated Revenue displays only one side of the solution, while the remaining revenue consists of the expenses side of things. Considering only one side of expenses while overlooking the other side leads to a wrong calculation. Hence the revenue and expenses are both considered for calculating the cap_rate for each year. The cap rate is calculated based on the two kinds of expenses: one kind of expense is a non-recurring or one-time (cost) expenses. The non-recurring expenses includes purchase price, furnishing cost, etc. Another or second kind of expense is a Recurring cost which includes Repair and maintenance, Insurance, Property Tax, HOA fees, etc.

According to an embodiment herein, the two kinds of expenses are respectively calculated using the respective equations.
a) The property tax is calculated using the following equation.
$$\begin{matrix}\text{Property tax =} \left(\text{Property Tax Percentage / 100}\right) \times \\ \text{purchase price} \text{.}\end{matrix}$$
b) The closing cost is calculated using the following equation.
$$\begin{matrix}\text{Closing cost =} \left(\text{Closing Cost Percentage/100}\right) \times \\ \left(\text{Purchase Price + Furnishing Cost}\right)\end{matrix}$$
c) The utility is calculated using the following equation.
$$\text{Utility} \text{=} \left(\text{Utility Percentage/100}\right) \times \text{Purchase Price} \text{.}$$
d) The total usage cost is calculated using the following equation.
$$\text{Total Usage = Purchase Price + Furnishing cost + Closing Cost}$$
e) The Property Management Cost is calculated using the following equation.
$$\begin{matrix}\text{Property Management =} \\ \left(\text{Repair and maintenance percentage/100}\right) \times \\ \text{Estimated Annual Revenue} \text{.}\end{matrix}$$
f) The operating expenses is calculated using the following equation.
$$\begin{matrix}\text{Operating Expenses = Utility + Property Tax + Insurance +} \\ \text{HOA Fees + Property management +} \\ \text{Repair and maintenance cost} \text{.}\end{matrix}$$
g) The Net Operating Income is calculated using the following equation.
$$\begin{matrix}\text{Net Operating Income = Estimated Annual Revenue +} \\ \text{Operating Expenses} \text{.}\end{matrix}$$
h) The Cap Rate is calculated using the following equation.
$$\text{Cap Rate =} \left(\text{Net Operating Income/Total uses}\right) \times 100.$$
Generally, properties with a cap rate above 6% are considered good, and those above 10% are considered excellent for the investment.

According to an embodiment herein, an asymptotic exponential function is used to transform the cap rate into the financial score. Mathematically,

$$F i n a n c i a l S c o r e = 100 \left[1 \text{- exp} \left(\text{- Cap\_Rate/4} \text{.5}\right)\right]$$

The above process to calculate financial scores has the following shortcomings: The process does not account for the uniqueness of property:
a) Property types like treehouses, farmhouses, etc. have uniqueness as their selling points. This method of selecting comps and using their past data to predict the future gloss over the individuality and distinctness of a property
b) Aesthetics and sizes: Even two nearby properties with exactly similar features, are mutually different in aesthetic appearance and parameters. Aesthetics, placement of bedrooms and bathrooms, and size of the property play a vital role in revenue estimation, which is completely ignored in this implementation of Financial Score. Maybe, Aesthetics, room positioning, and sizes should be taken care of in the HUMINT platform.

According to an embodiment herein, the proximity sore is calculated based on store score, restaurant score, airport score, attraction score and down town score.

According to an embodiment herein, the store score is calculated based on the nearby stores data received from the Google API with respect to property location.

According to an embodiment herein, a restaurant score is calculated based on nearby restaurant data received from the Google API with respect to property location.

According to an embodiment herein, the airport score is calculated based on the nearby airports data received from the Google API with respect to property location.

According to an embodiment herein, the attraction score is calculated based on the nearby attractions facility data received from the Google API with respect to property location.

According to an embodiment herein, the downtown score is calculated based on the nearby downtowns data received from downtown database respect to property location.

According to an embodiment herein, the Proximity Score is calculated based on many factors like schools/colleges/universities, hospitals/clinics, gym/fitness centers, train stations/bus stations, restaurants, stadiums, downtowns/business centers, museums, churches, parks, theatres, and many more, that are looked into to evaluate or judge whether a given area is a good spot for short term rentals. It is practically not feasible to take into account all of these factors. So, these samples give us a reliable picture of all the categories. The categories selected are Stores, Restaurants, Downtowns, Airports, and Attraction (which includes museums, parks, theatres, churches, and any other things that are tagged as tourist attractions). Google Place API is calculated to retrieve data for Stores, Restaurants, Airports, and Attractions. Since there is no information about the downtown in the Google API, a downtown database is used for it. A proximity Score is calculated based on store score, restaurant score, airport score, attraction score, and downtown score.

According to an embodiment herein, the proximity score comprises a store score. The store score is calculated as people do not intend to travel farther in search of a store. Thus, they only look for stores within a radius of 6000 m (assumed). Note that, 6000 m here is a Euclidean distance (Circumferential Distance to be exact), which means the distance of an actual path joining a desired location to the store can be greater than 6000 m. The steps of calculating the store score or value are given as follows. Let us say there S₁, S₂, S₃ are three stores and with ratings r₁, r₂, r₃, number of ratings n₁, n₂, n₃ and at a distance d₁, d₂, d₃ respectively from the desired location. Each of the stores adds a little bit of value to the desired location. To calculate the value that a store adds to a property at a distance d, the following points are assumed:
i. The higher the rating, the higher the value added
ii. The higher the number of ratings, the higher the value added
iii. The nearer the store, the higher the value added

Heuristically, we have derived the value added by the store S₁on our location, and it is obtained by multiplying the square root of n₁ with r₁ and dividing the multiplication product by a square of distance d₁, mathematically Value_added = (square root of n₁ x r₁)/square of d₁

The number of ratings is square rooted because it has a high variance. The value added is inversely proportional to the square of a distance to the store. This is because people choose a nearby store even if it is a little worse compared to another better store which is a little bit farther.

Then, the total store value in our location is:

$$\begin{matrix}t o t a l \_ s t o r e \_ v a l u e = \sum v a l u e \_ a d d e d \_ b y \_ t h e \_ s t o r e \\ \left(a l l \text{} \_ \text{} s t o r e s\right)\end{matrix}$$

The total store value is then transformed into the store_score of a property:

$$s t o r e \_ s c o r e = 100 \left(1 - exp \left(- t o t a l \_ s t o r e \_ v a l u e\right)\right)$$

According to an embodiment herein, the proximity score further comprises a restaurant score. Normally the people travel a bit farther when it comes to restaurants. Thus, the people only look for restaurants within a radius of 20000 m (Euclidean). Note that an increase the radius is costlier since the returned response is paginated on more pages, each of which charges us more bucks.

A value added to our property by restaurant Riwith rating r₁, number of rating n₁, and at a distance di from our location is:

$$\text{Value\_added} = \left({\text{square root of n}}_{1} {\text{x r}}_{1}\right) / {\text{d}}_{1} {}^{1.5}$$

Value added is inversely proportional to the 1.5th power of a distance to the restaurant. This is because people are more willing to travel farther distances if restaurants there are better than those nearby. Then, the total restaurant value in our location is:

$$\begin{matrix}\text{i} \text{.} t o t a l \text{} \_ \text{} r e s t a u r a n t \text{} \_ \text{} v a l u e = \sum v a l u e \text{} \_ \text{} a d d e d \text{} \_ \text{} b y \text{} \_ \text{} t h e \text{} \_ \text{} r e s t a u r a n t \\ a l l \text{} \_ \text{} r e s t a u r a n t s\end{matrix}$$

The total restaurant value is transformed into a restaurant score using:

$$\begin{matrix}R e s t a u r a n t S c o r e = 100 \left(1 - exp \left(- \text{total\_} r e s t a u r a n t \text{} \_ \text{} v a l u e\right)\right) \\ \text{10} \text{.0}\end{matrix}$$

The value 10.0 in the exponent is obtained empirically. The restaurant score was calculated at the different places in a desired location or city and 10.0 was found to be more apt.

According to an embodiment herein the proximity score further comprises an Attraction Score which is calculated as follows:
The threshold radius for attractions is assumed to be 35000 m. A value added to the selected property by restaurant Riwith rating r₁, number of rating n₁, and at a distance d₁ from our location is given below:
The attraction value added is obtained by multiplying the square root of n₁ with r₁ and dividing the multiplication product by the 1.5th power of a distance d₁. It is mathematically represented as

$$\text{Value\_added} = \left({\text{square root of n}}_{1} {\text{x r}}_{1}\right) / {\text{d}}_{1} {}^{1.5}$$

Then, the total attraction value in our location is:

$$\begin{matrix}\text{Total attraction value =} \sum \text{value added by an attraction center} \\ \text{all attaction centers}\end{matrix}$$

The total attraction value is transformed into an attraction score using the following equation:

$$A t t r a c t i o n S c o r e = 100 \left[1 - \text{exp} \left(- 1.5 \text{tot} a l \_ a t t r a c t i o n \_ v a l u e\right)\right]$$

According to an embodiment herein, the proximity score includes an airport score. The threshold radius for the airport is assumed to be 45000 m. (With a quick search in google maps, 45 km of Euclidean distance is covered in around 2 hours in a given city or location).

A value added to our property by airport A₁ with rating r₁, number of rating n₁, and at a distance d₁ from our location is:

$$v a l u e \_ a d d e d = \frac{\text{multiplier} \sqrt{\times } {\text{n}}_{1} \times }{{d}_{1}}$$

where the multiplier is equal to:
20 if international is present in the airport’s name; and
0 if any of helipad, heliport, helicopter, or aviation is present in the airport’s name else it is 1.

Value added is inversely proportional to only the distance (power 1).

This is because an airport is an obligatory place if one wants to travel the nearby locations. Then, the total airport value in our location is:

$$\begin{matrix}\text{Total airport value =} \sum \text{Value added by the airport} \\ \text{all airports}\end{matrix}$$

The total airport value is transformed into an airport score using:

$$\text{Airport score = 100} \left(1 \text{-exp} \left[\text{-total airport value}\right]\right) / 3.$$

According to an embodiment herein, the proximity score further includes a downtown score. In downtown score calculating process, a manually compiled database is searched to obtain data of the nearby downtowns. Since there is no information about average ratings and the total number of ratings, value-added by downtown at a distance is calculated as:

$$\text{Value added} = 1 / {\text{d}}_{1} {}^{1.5}$$

Then, the total downtown value in our location is:

$$\begin{matrix}\text{Total downtown\_value} = \sum \text{Value added by the airport} \\ \text{all airports}\end{matrix}$$

The total downtown value is transformed into a downtown score using:

$$\text{downtown score} = 100 \left(1 - exp \left[- 30 \text{x total downtown value}\right]\right) .$$

The proximity score is calculated using the equation:

$$\begin{matrix}p r o x i m i t y \text{} \_ \text{} s c o r e = 0.1 \times d o w n t o w n \text{} \_ \text{} s c o r e + \\ 0.1 \times r e s t a u r a n t \text{} \_ \text{} s c o r e + 0.3 \times a i r p o r t \text{} \_ \text{} s c o r e + \\ 0.2 \times s t o r e \text{} \_ \text{} s c o r e + 0.1 x a t t r a c t i o n \text{} \_ \text{} s c o r e .\end{matrix}$$

According to an embodiment herein, the market sore is calculated based on walk score, crime score, density score, appreciation score, job prospect score, weather score, air quality score, water quality score, and short-term rental score.

According to an embodiment herein, the walk score is calculated based on the data received from the walk score API with respect to property location.

According to an embodiment herein, a crime score is calculated based on Violent crime index and Property Crime index received from market data with respect to property location.

According to an embodiment herein, a population density score is calculated based on population density index received from the market data with respect to property location.

According to an embodiment herein, a market appreciation score is calculated based on house appreciation value in year and the house appreciation value in 5 years obtained from the market data with respect to property location.

According to an embodiment herein, a job prospect score is calculated based on unemployment rate and future job growth rate obtained from the market data with respect to property location.

According to an embodiment herein, a weather score is calculated based on weather comfortability data obtained from the market data with respect to property location.

According to an embodiment herein, an air quality score and a water quality score are calculated based on air quality data and water quality data obtained from the market data with respect to property location.

According to an embodiment herein, a short-term rental score is calculated based on short term rental trend data derived from short term rental data obtained from the closest market data with respect to property location.

According to an embodiment herein, the short-term rental prospect is only considered in the financial score and is not considered in the appreciation of real estate. A user or buyer is always interested in investing in the properties, with the aim of selling the property at a higher price in a later date. Additionally, it is myopic to consider that the later period is just one year. Another thing which is missed out in the process is the growth of the market in terms of demography, employment, and other socio-environmental aspects like weather quality, comfort index, crime rates, etc. The market score is calculated to covers them all. The data dump from a social or government database is collected to obtain data about crime, demographics, house appreciation, job prospects, weather comfortability, air quality, and water quality. Walk score API is used to get the walk score. The short-term rental trend is obtained using real estate market data. The market score is also a weighted average of its component scores. The component scores are walk score, crime score, House Appreciation Score, Job prospect score, Population density score, Weather score, air quality score, water quality score, short-term rental trend score. The market score is calculated mathematically as follows:

$$\begin{matrix}M a r k e t \text{} \_ \text{} s c o r e = 0.1 \times w a l k \text{} \_ \text{} s c o r e + \\ 0.05 \times p o p u l a t i o n \text{} \_ \text{} d e n s i t y \text{} \_ \text{} s c o r e + 0.1 \times c r i m e \text{} \_ \text{} s c o r e + \\ 0.2 \times h o u s e \text{} \_ \text{} a p p r e c i a t i o n \text{} \_ \text{} s c o r e + 0.1 \times j o b \text{} \_ \text{} p r o s p e c t \text{} \_ \text{} s c o r e + \\ 0.1 \times w e a t h e r \text{} \_ \text{} s c o r e + 0.05 \times \text{a} i r \text{} \_ \text{} q u a l i t y \text{} \_ \text{} s c o r e + \\ 0.05 \times w a t e r \text{} \_ \text{} q u a l i t y \text{} \_ \text{} s c o r e .\end{matrix}$$

According to an embodiment herein, the market score comprises a Walk score. The Walk Score helps to find a walkable place to live. Walk Score is a number between 0 and 100 that measures the walkability of any address. It is obtained directly from the Walk score API.

According to an embodiment herein, the market score comprises Population Density Score. The Population Density Score is calculated as follows. The Population density obtained is in terms of per sq. km. Usually, neither too high nor too low population density is considered good. Thus, the density score is expected to increase if the density increases up to some point, beyond which the density score is expected to decrease. A bell-shaped function (binomial distribution) with a mean of 15000 and a standard deviation of 20000 is used to convert population density to the score.

$$\text{Population} \text{Density} \text{Score} = 100 \times \text{exp} \frac{[ - ( \text{population} \text{density} - 15000 ) ]}{20000}$$

According to an embodiment herein, the market score comprises a crime score. The crime score is calculated as follows. Violent crime index and Property Crime index in an area are obtained from the database, both ranging from 0 to 100 (the lower the crime index, the safer the area). Crime Score is calculated as:

$$\text{Crime} \text{} \_ \text{} \text{Score} = 100 - ( \text{violent} \text{crime} \text{index} + \text{property} \text{crime} \text{index} ) \text{} / \text{} 2.$$

According to an embodiment herein, the market score comprises a house appreciation score. The House Appreciation score is calculated as follows. The data base provides us with the data regarding house appreciation in the last year as well as in the last five years. The appreciation values are provided in a way that

$$\begin{matrix}\text{current\_house\_price = house\_price\_last\_year} \times \\ \left(\text{1 + appreciation\_last\_year}\right) .\end{matrix}$$

$$\begin{matrix}\text{Similarly, current\_house\_price = price\_5yrs\_ago} \times \\ \left(1 + \text{appreciation\_in\_5yrs}\right) .\end{matrix}$$

The house appreciation score is calculated as:

$$\begin{matrix}\text{Appreciation\_score = 0} \text{.7} \times \text{appreciation\_last year +} \\ \text{0} \text{.3} \times \left(1 / 5\right) \times \text{appreciation\_5 years} \text{.}\end{matrix}$$

A weightage of ⅕ is used to convert the 5 yr appreciation score into the frame of 1 year. The weights of 0.7 and 0.3 are the weight associated with appreciation last year and appreciation in the last five years, respectively.

According to an embodiment herein, the market score comprises a Job Prospect Score. The Job Prospect Score is calculated as follows. The current unemployment rate and future job growth index are obtained from the data base. The data is in such a unit that

$$\text{Employed} \_ \text{fraction} = \text{1} - \text{unemployment} \_ \text{rate}$$

$$\begin{matrix}\text{Future} \text{} \_ \text{} \text{employed} \text{} \_ \text{} \text{fraction} \text{} = \\ \text{} \text{Current} \text{} \_ \text{} \text{employed} \text{} \_ \text{} \text{fraction} \times ( 1 \text{} + \text{} \text{job} \text{} \_ \text{} \text{growth} )\end{matrix}$$

Combining these two equations:

$$\begin{matrix}\text{Future} \_ \text{employed} \_ \text{fraction} = \\ ( 1 - \text{unemployment} \_ \text{rate} ) \times ( 1 + \text{job} \_ \text{growth} )\end{matrix}$$

The future employed fraction is then converted into the job prospect score as:

$$\begin{matrix}J o b \text{} \_ \text{} p r o s p e c t \text{} \_ \text{} s c o r e = 100 \times \\ \left(1 - e x p \left(- 2 \times f u t u r e \text{} \_ \text{} e m p l o y e d \text{} \_ \text{} f r a c t i o n\right)\right) .\end{matrix}$$

According to an embodiment herein, the market score comprises Weather Score. The Weather score is calculated as follows: Weather comfortability is obtained from a database, and it ranges from 0 to 10, out of which 10 indicates the best. To convert weather comfortability range into a weather score, it is simply multiplied by 10.

$$\text{Weather} \text{} \text{\_} \text{} \text{score} = 10 \times \text{weather\_comfortability}$$

According to an embodiment herein, the market score comprises Air Quality Score and Water quality score. The Air quality and water quality score is calculated as follows: Air quality and water quality of the closest city are obtained from the database, both ranging from 0 to 100, 100 being the best. These values are used as it is in the air quality score and water quality score.

According to an embodiment herein, the market score comprises Short-term rental trend score. The short-term rental trend score is calculated by filtering by location with a radius of 2000 m, and k=100 is used to find the market.

Finally, the market score is calculated mathematically as follows:

$$\begin{matrix}M a r k e t \text{} \_ \text{} s c o r e = 0.1 \times w a l k \text{} \_ \text{} s c o r e + \\ 0.05 \times p o p u l a t i o n \text{} \_ \text{} d e n s i t y \text{} \_ \text{} s c o r e + 0.1 \times c r i m e \text{} \_ \text{} s c o r e + \\ 0.2 \times h o u s e \text{} \_ \text{} a p p r e c i a t i o n \text{} \_ \text{} s c o r e + 0.1 \times j o b \text{} \_ \text{} p r o s p e c t \text{} \_ \text{} s c o r e + \\ 0.1 \times w e a t h e r \text{} \_ \text{} s c o r e + 0.05 \times \text{a} i r \text{} \_ \text{} q u a l i t y \text{} \_ \text{} s c o r e + \\ 0.05 \times w a t e r \text{} \_ \text{} q u a l i t y \text{} \_ \text{} s c o r e .\end{matrix}$$

According to an embodiment herein, the final investment ranking score is a weighted average of its components comprising a financial score, a proximity score, and a market score. The final investment score is mathematically represented by the following equation:

$$\begin{matrix}\text{Final Investment Ranking Score} = 0.5 \times f i n a n c i a l \text{} \_ \text{} s c o r e + \\ 0.2 \times p r o x i m i t y \text{} \_ \text{} s c o r e + 0.2 \times m a r k e t \text{} \_ \text{} s c o r e .\end{matrix}$$

According to an embodiment herein, a method for ranking analysis of the property is provided. The method comprises the following steps. A plurality of property data is periodically collected or scrapped from the real estate website of the third parties. The data collected from the real estate website of the third parties are checked, and verified to find a valid authenticity of the property. When the valid authenticity of the property is correct and successful, an additional data is collected from the third-party providers. The data collected from the third-party providers are cleaned, transformed, and aggregated. The cleaned, transformed, and aggregated data collected from the third-party providers are checked for the legal validity. When the legal validity of the cleaned, transformed, and aggregated data collected from the third-party providers are found to be valid and successful, the data are again judged to find whether the successfully validated data meet the primary criteria. When the successfully validated data meet the primary criteria, a final ranking score is assigned to the property under consideration. When the score is found to be less than a threshold limit, the analysis and recommendation of the property for investment is discarded. When the score is found to be more than a threshold limit, the property is passed to human platform for human analysis. When the property is accepted by the platform for human analysis, positive feedback is provided to the system. When the property is not accepted by the platform for human analysis, negative feedback is provided to the system.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a flow chart explaining a method for performing a financial analysis to obtain a financial score of the property under consideration, according to an embodiment herein;

FIG. 2 illustrates a flow chart explaining a method for performing a proximity analysis to obtain a proximity score of the property under consideration, according to an embodiment herein;

FIG. 3 illustrates a flow chart explaining a method for performing a market analysis to obtain a market score of the property under consideration, according to an embodiment herein; and

FIG. 4 illustrates a method for analysing properties at a scale on more than 25 mutually different factors and assigning them a score from 0-100 to identify a strong investment on a selected property using artificial intelligence model, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF PREFERRED EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

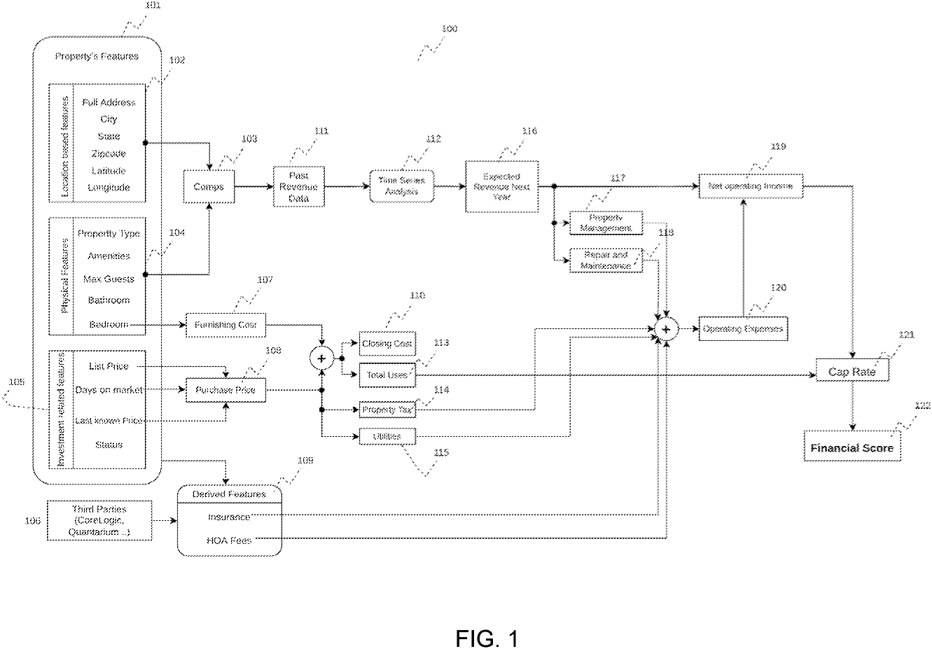

FIG. 1 illustrates a flow chart (100) explaining a method for performing a financial analysis to obtain a financial score of the property. With respect to FIG. 1, property features (101) may include location features (102), physical features (104) and investment related features (105). The location features (102) or parameters or data of a property includes full address of the property, and wherein the address includes name of the city in which the property is located, state, Zip code, latitude, and longitude of the property.

According to an embodiment herein, the physical features (104) or parameters or data includes a type of property, and amenities provided in the property. The amenities include maximum number of guests accommodated in the property, number of bathrooms and bedrooms provided in the property. A furnishing price (107) of the property is calculated based on the number of bedrooms and number of bathrooms.

According to an embodiment herein, the full address data, zip code, the latitude and longitude, and the physical features or parameters or data are used to identify the comparable short term rental properties (103). The past revenue records (111) of those properties are subjected to time series analysis (112) to compute an expected yearly revenue (116) for the property.

According to an embodiment herein, the investment related features (105) of the property comprise listed price of the property on market, the number of days on market with the listed price, and the last known price on the market, and the current status of the property. A purchase price (108) of the property is calculated based on the listed price of the property on market, the number of days on market with the listed price, and the last known price on the market. A property tax (114) and the utilities cost (115) are calculated based on the computed purchase price of the property. A closing cost (110) and the total uses cost (113) are calculated based on the computed purchase value (108) and computed furnishing cost (107).

According to an embodiment herein, a plurality of derived parameters (109) is calculated based on the collected investment related parameters by the third-party system (106). The derived parameters include an insurance cost and the HOA fees (109) for the property.

According to an embodiment herein, a property management cost (117), and a repair and maintenance cost (118) are calculated based on the estimated expected yearly revenue of the property (116).

According to an embodiment herein, an operating expense (120) for the property is calculated by an adder or summation module based on the computed property management cost (117), the computed repair and maintenance cost (118), the computed property tax (114), the computed utilities cost (115), the computed insurance cost and the computed HOA fees (109) for the property.

According to an embodiment herein, a net operating income (119) is calculated based on the estimated expected yearly revenue of the property (116) and the computed operating expenses of the property (120).

According to an embodiment herein, a cap rate (121) for the property is calculated based on the computed net operating income and the total utility cost of the property. A financial score (122) of the property is calculated based on the computed cap rate for the property.

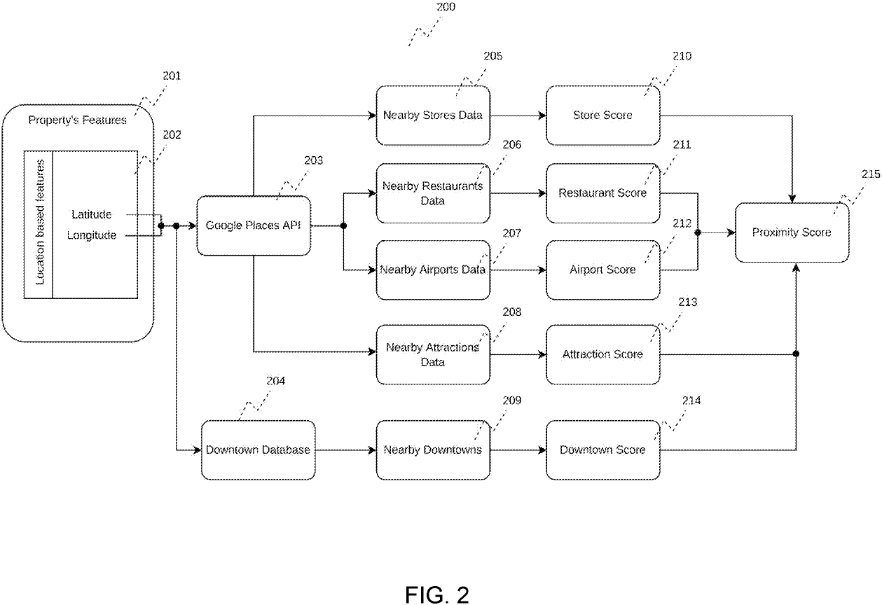

FIG. 2. illustrates a block diagram (200) to depict as to how the Proximity Score is calculated to evaluate or judge whether a given area is a good spot for short term rentals. The places of interest that are looked into are Stores, Restaurants, Downtowns, Airports, and Attraction (which includes museums, parks, theatres, churches, and any other things that are tagged as tourist attractions). Property’s location-based parameter or data or features (201) like latitude and longitude (202) are provided to Google Places API (203) to retrieve data for nearby Stores (205), Restaurants (206), Airports (207), and Attractions (208). Since there is no information about the downtown in the Google API, a downtown database (204) is used to retrieve data from a nearby downtown 209. A proximity Score (215) is calculated based on store score (210), restaurant score (211), airport score (212), attraction score (213), and downtown score (214).

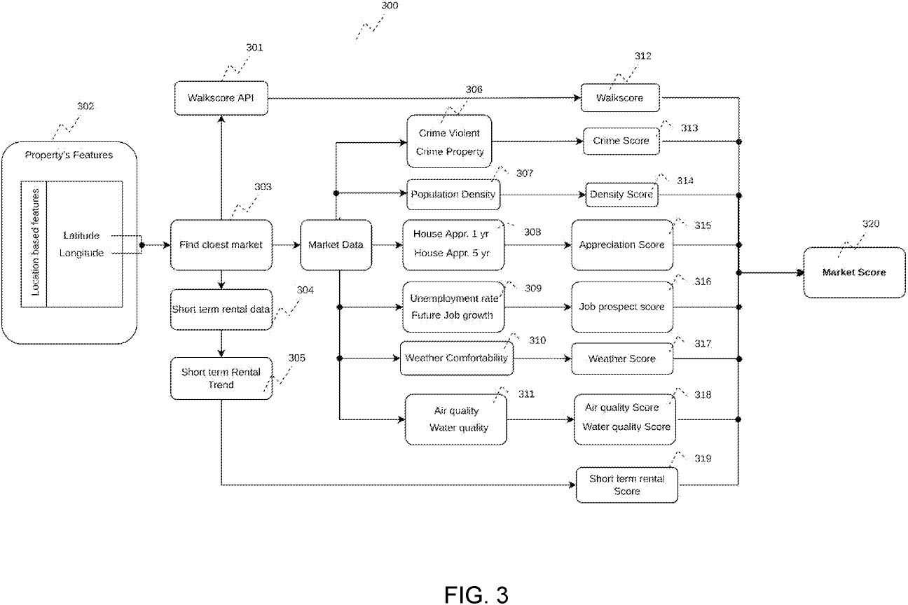

FIG. 3 illustrates a flow chart (300) showing the computation of Market Score (320) with respect to property features (302). According to an embodiment herein, the market score comprises a Walk score (312). The Walk Score helps to find a walkable place to live. Walk Score is a number between 0 and 100 that measures the walkability of any address. It is obtained directly from the Walk score API (301).

According to an embodiment herein, the market score (320) comprises Population Density Score (314). The Population Density Score is calculated as follows. The Population density (307) obtained is in terms of per sq. km. Usually, neither too high nor too low population density is considered good. Thus, the density score (314) is expected to increase if the density increases up to some point, beyond which the density score (314) is expected to decrease. A bell-shaped function (binomial distribution) with a mean of 15000 and a standard deviation of 20000 is used to convert population density to the score.

$$\begin{matrix}\text{Population Density Score} = \text{100 x} \\ \text{exp} \left[\text{-} \left(\text{population density-15000}\right)\right] \\ \text{20000}\end{matrix}$$

According to an embodiment herein, the market score (320) comprises a crime score (313). The crime score is calculated as follows. Violent crime index and Property Crime index (306) in an area are obtained from the marked data present the closest market database (303), both ranging from 0 to 100 (the lower the crime index, the safer the area). Crime Score (313) is calculated as:

$$\begin{matrix}\text{Crime\_Score =} \\ \text{100 -} \left(\text{violent crime index + property crime index}\right) / 2.\end{matrix}$$

According to an embodiment herein, the market score (320) comprises a house appreciation score (315). The House Appreciation score is calculated as follows. The data base provides us with the data regarding house appreciation in the last year as well as in the last five years (308) obtained from the marked data present in the closest market database (303). The appreciation values are provided in a way that

$$\begin{matrix}\text{current\_house\_price = house\_price\_last\_year} \times \\ \left(1 \times \text{appreciation\_last\_year}\right) .\end{matrix}$$

$$\begin{matrix}\text{Similarly, current\_house\_price = price\_5yrs\_ago} \times \\ \left(\text{1 + appreciation\_in\_5yrs}\right) .\end{matrix}$$

The house appreciation score is calculated as:

$$\begin{matrix}\text{Appreciation\_score} = \text{0} \text{.7 x appreciation\_last year +} \\ \text{0} \text{.3 x} \left(1 \text{/5}\right) \text{x appreciation \_5 years} \text{.}\end{matrix}$$

A weightage of ⅕ is used to convert the 5 yr appreciation score into the frame of 1 year. The weights of 0.7 and 0.3 are the weight associated with appreciation last year and appreciation in the last five years, respectively.

According to an embodiment herein, the market score (320) comprises a Job Prospect Score (316). The Job Prospect Score (316) is calculated as follows. The current unemployment rate and future job growth index (309) are obtained from the marked data present in the closest market database (303). The data is in such a unit that

$$\text{Employed\_fraction} = 1 - \text{unemployment\_rate}$$

$$\begin{matrix}\text{Future\_employed\_fraction} = \text{Current\_employed\_fraction} \times \\ \left(1 + \text{job\_growth}\right)\end{matrix}$$

Combining these two equations:

$$\begin{matrix}\text{Future\_employed\_fraction} = \left(1 - \text{unemployment\_rate}\right) \times \\ \left(1 + \text{job\_growth}\right)\end{matrix}$$

The future employed fraction is then converted into the job prospect score as:

$$\begin{matrix}\text{Job\_prospect\_score} = 100 \times \\ \left(1 - \text{exp} \left(- 2 \times \text{future\_employed\_fraction}\right)\right) .\end{matrix}$$

According to an embodiment herein, the market score (320) comprises Weather Score (317). The Weather score is calculated as follows: Weather comfortability (310) is obtained from the marked data present in the closest market database (303), and it ranges from 0 to 10, out of which 10 indicates the best. To convert weather comfortability range into a weather score, it is simply multiplied by 10.

$$\text{Weather\_score} \text{=} \text{10} \times \text{weather\_comfortability}$$

According to an embodiment herein, the market score (320) comprises Air Quality Score and Water quality score (318). The Air quality and water quality score is calculated as follows: Air quality and water quality (311) of the closest city are obtained from the marked data present in the closest market database (303), both ranging from 0 to 100, 100 being the best. These values are used as it is in the air quality score and water quality score.

According to an embodiment herein, the market score (320) comprises Short-term rental trend score (319) based on short term rental trend data (305) derived from short term rental data (304) obtained from the closest market data base (303) with respect to property location. The short-term rental trend score (319) is calculated by filtering by location with a radius of 2000 m, and k=100 is used to find the market.

Finally, the market score (320) is calculated mathematically as follows:

$$\begin{matrix}\text{Market\_score} \text{=} \text{0} \text{.1} \times \text{walk\_score + 0} \text{.05} \times \\ \text{population\_density\_score + 0} \text{.1} \times \text{crime\_score + 0} \text{.2} \times \\ \text{house\_appreciation\_score +0} \text{.1} \times \text{job\_prospect\_score +} \\ \text{0} \text{.1} \times \text{weather\_score + 0} \text{.05} \times \text{air\_quality\_score + 0} \text{.05} \times \\ \text{water\_quality\_score} \text{.}\end{matrix}$$

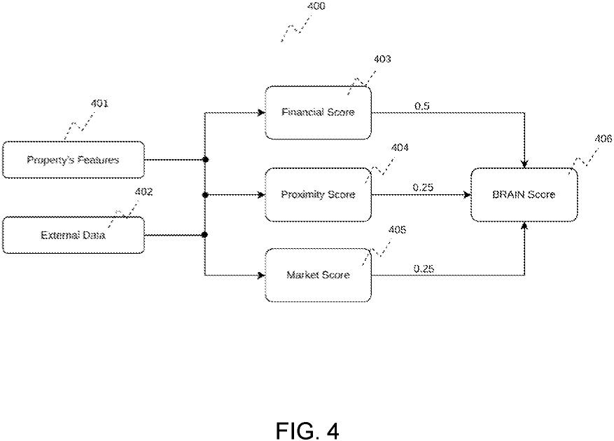

FIG. 4. illustrates a block diagram (400) depicting the calculation of the final investment ranking score or BRAIN score (406). It is calculated as a weighted average of its components comprising financial score (403), proximity score (404) and market score (405), which are based on the property features (401) and the external data (402). The final investment score is mathematically represented by the following equation:

$$\begin{matrix}\text{Final Investment Ranking Score = 0} \text{.5} \times \text{financial\_score +} \\ \text{0} \text{.25} \times \text{proximity\_score + 0} \text{.25} \times \text{market\_score}\end{matrix}$$

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A computer implemented system comprising hardware processor and memory stored with a plurality of computer implemented instructions for analysing, evaluating and ranking properties with respect to investments on properties, based on a plurality of mutually different factors using artificial intelligence through one or more algorithms or software applications, the system comprises:
a data collection module run on the hardware processor and configured to collect a plurality of data related to a plurality of properties under consideration from a plurality of sources by means of API connection, web scraping from various third party systems through one or more applications or algorithms, and wherein the plurality of data comprises a plurality of location based parameters, a plurality of physical parameters related to the plurality of properties, and a plurality of investment related parameters of the plurality of properties;
a primary filter run on the hardware processor and configured to remove the plurality of properties that do not meet a preliminary criterion from an acquisition pipeline through the one or more applications or algorithms, and wherein the plurality of criteria comprises legal, crime rating, liability, and liveability, criteria of the plurality of properties;
a ranking engine comprising an artificial intelligence (AI) model loaded on the hardware processor and run on the hardware processor to execute the instruction stored on a memory to receive and analyse the plurality of collected data on the plurality of properties to provide a ranking based investment score for a property under evaluation or consideration;
a web-based application to compliment the investment score provided by the AI model to enable analysts to evaluate and provide a final ranking-based investment score for the property under valuation, and wherein the final ranking score is used to retain the AI model;
wherein the final ranking-based investment score comprises two components, and wherein the final ranking-based investment score is a weighted sum of proximity score, market score and financial score, and wherein the final ranking-based investment score is obtained mathematically using an equation:
$$\begin{matrix}\text{the final ranking-based investment score =} \\ \text{0} \text{.25 * Proximity Score + 0} \text{.25 * Market Score + 0} \text{.5 *} \\ \text{Financial Score;}\end{matrix}$$
wherein the proximity score comprises downtown score, restaurant score, airport score, attraction score, and store score, and wherein the market score comprises walk score, population density score, crime score, house appreciation score, job prospect score, weather score, air quality score, and water quality score, and wherein the final investment ranking score is simply a weighted sum of financial score, proximity score and market score, and wherein the brain score is mathematically represented as:
$$\begin{matrix}\text{Brian Score = 0} \text{.25 * proximity score + 0} \text{.25 *} \\ \text{market score + 0} \text{.5 * Financial Score,}\end{matrix}$$
and wherein the proximity score is calculated using the equation:
$$\begin{matrix}p r o x i m i t y \_ s c o r e = 0.1 \times d o w n t o w n \_ s c o r e + 0.1 \times \\ r e s t a u r a n t \_ s c o r e + 0.3 \times a i r p o r t \_ s c o r e + 0.3 \times \\ s t o r e \_ s c o r e + 0.1 \times a t t r a c t i o n \_ s c o r e \text{;} \text{and}\end{matrix}$$
wherein the market score is calculated mathematically as follows:
$$\begin{matrix}M a r k e t \_ s c o r e = 0.1 \times w a l k \_ s c o r e + 0.05 \times \\ p o p u l a t i o n \_ d e n s i t y \_ s c o r e + 0.1 \times c r i m e \_ s c o r e + 0.2 \times \\ h o u s e \_ a p p r e c i a t i o n \_ s c o r e + 0.1 \times j o b \_ p r o s p e c t \_ s c o r e + \\ 0.1 \times w e a t h e r \_ s c o r e + 0.05 \times a i r \_ q u a l i t y \_ s c o r e + 0.05 \times \\ w a t e r \_ q u a l i t y \_ s c o r e\end{matrix}$$
.

2. The system according to claim 1, wherein the plurality of location-based parameters comprises full address of the property, and wherein the address includes name of the city in which the property is located, state, zip code, latitude, and longitude of the property.

3. The system according to claim 1, wherein the plurality of physical parameters or data comprises a type of property and amenities provided in the property, and wherein the amenities include maximum number of guests accommodated in the property, number of bathrooms and bedrooms provided in the property, and wherein a furnishing price of the property is calculated based on the number of bedrooms and number of bathrooms.

4. The system according to claim 1, wherein AI model is configured to perform a cohort analysis on the location-based parameter including full address data, zip code, the latitude and longitude coordinates, and the physical parameters to obtain an output, and wherein an output of the cohort analysis is subjected to time series analysis to compute an expected month-wise ADR and an expected month-wise reservation days to compute an expected yearly revenue for the property.

5. The system according to claim 1, wherein the investment related features of the property comprise listed price of price of the property on market, the number of days on market with the listed price, and the last known price on the market, and the current status of the property, and wherein a purchase price of the property is calculated based on the listed price of price of the property on market, the number of days on market with the listed price, and the last known price on the market, and wherein a property tax and the utility tax are calculated based on the computed purchase price of the property, and wherein a closing coat and the total utility cost are calculated based on the computed purchase value and computed furnishing cost.

6. The system according to claim 1, wherein a plurality of derived parameters is calculated based on the collected investment related parameters, and wherein the derived parameters include an insurance cost and the HOA fees for the property.

7. The system according to claim 1, wherein a property management cost, and a repair and maintenance cost are calculated based on the estimated expected yearly revenue of the property.

8. The system according to claim 1, wherein an operating expense for the property is calculated based on the computed property management cost, the computed repair and maintenance cost, the computed property tax, the computed utility tax, the computed insurance cost and the computed HOA fees for the property.

9. The system according to claim 1, wherein a net operating income is calculated based on the estimated expected yearly revenue of the property and the computed operating expenses of the property.

10. The system according to claim 1, wherein a cap rate for the property is calculated based on the computed net operating income and the total utility cost of the property, and wherein a financial score of the property is calculated based on the computed cap rate for the property.

11. The system according to claim 1, wherein the collected location-based data and the collected physical parameter data of the property under consideration are filtered using a filtering module to find short term rentals of the property similar to the property under consideration, and wherein the parameters used for filtering comprises latitude and longitude coordinates, Zip code, number of bed rooms, and number of bath rooms, maximum number of guests to be accommodated, and type of property, and amenities provided in the property for the property under consideration, and wherein the property under consideration is ignored and ranked of least interest or ranking, when the number of computations obtained based on the search criteria is less than 12, and wherein the number of filtering criteria is reduced until at least a dozen computations are obtained, and wherein a dozen computations are obtained, when the number of filtering criteria is greater than 4, and wherein the number of filtering criteria is equal to or less than 4, a search for the property in a broader vicinity is conducted, and wherein, at least a dozen properties with their monthly Revenue, ADR, occupancy rates, and reservation days are obtained after the completion of cohort analysis.

12. The system according to claim 1, wherein a time-series analysis is performed on the computed data to develop an AI model to estimate monthly ADR, occupancy rates, revenue, and reservation days of the property under consideration for the future.

13. The system according to claim 1, wherein a cap rate for the property is calculated using the AI algorithm which is executed on a hardware processor in the system, and wherein the steps of calculating the cap rate using the AI algorithm are as follows:
a) Input property_tax_percentage, utility_percentage, closing_cost_percentage, property_management_percentage, repair_and_maintainance_percentage values;
b) Calculate the annual value using the following mathematical equation:
$$\begin{matrix}\text{annual\_revenue =} \\ \text{sum of month-wise product of ADR and reservation days;}\end{matrix}$$
c) Calculate the property tax using the following mathematical equation:
$$\begin{matrix}\text{property\_tax =property\_tax\_percentage/100 *} \\ \text{purchase\_price;}\end{matrix}$$
d) Calculate the utility value using the following mathematical equation:
$$\text{utility = utility\_percentage/100} \text{*} \text{purchase\_price} ;$$
e) Calculate the property management cost using the following mathematical equation:
$$\begin{matrix}\text{property\_management =} \\ \text{property\_management\_percentage/100*annual\_revenue} ;\end{matrix}$$
f) Calculate the repair and maintenance cost of the property using the following mathematical equation:
$$\begin{matrix}\text{repair\_and\_maintainance} \text{=} \\ \text{repair\_and\_maintainance\_percentage} \text{/} \text{100} \text{*} \\ \text{annual\_revenue} ;\end{matrix}$$
g) Calculate the operating expenses cost of the property using the following mathematical equation:
$$\begin{matrix}\text{operating\_expenses} \text{=} \text{utility} \text{+} \text{property\_tax} \text{+} \text{insurance} \text{+} \\ \text{HOA} \text{fees} \text{+} \text{property\_management} + \\ \text{repair\_and\_maintaince} ;\end{matrix}$$
h) Calculate the net operating income of the property using the following mathematical equation:
$$\text{net\_operating\_income} \text{=} \text{annual\_revenue} \text{- operating\_expenses} ;$$
i) Calculate the closing cost of the property using the following mathematical equation:
$$\begin{matrix}\text{closing\_cost} \text{=} \text{closing\_cost\_percentage} \text{/} \text{100 *} \\ \left(\text{purchase\_price + furniture\_price}\right) ;\end{matrix}$$
j) Calculate the total utility value of the property using the following mathematical equation:
$$\text{total\_uses = purchase\_price + furniture\_price + closing\_cost} ;$$
k) Calculate the cap rate for the property using the following mathematical equation:
$$\text{cap\_rate = net\_operating\_income / total uses * 100}$$
.

14. The system according to claim 1, wherein the financial score for the property is assigned based on the computed caprate value using an algorithm, and wherein the financial score is calculated using the algorithm as given below:
If cap_rate < 5: then the Financial_Score = 4 ∗ cap_rate;
If 5 < cap_rate < 16: then the Financial Score = 0.0017x5 - 0.0926x4+2.0435x3-23.1037x2+142.5287x - 317.7937;
If cap_rate > 16: then the Financial Score = 100.

15. A computer implemented comprising instructions stored on a non-transitory computer rabble storage medium and executed on a hardware processor provided in a computing system having memory, for analysing, evaluating and ranking properties with respect to investments on properties, based on a plurality of mutually different factors using artificial intelligence through one or more algorithms or software applications, the method comprises:
collecting a plurality of data related to a plurality of properties under consideration with a data collection module run on the hardware processor, from a plurality of sources by means of API connection, web scraping from various third party systems through one or more applications or algorithms, and wherein the plurality of data comprises a plurality of location-based parameters, a plurality of physical parameters related to the plurality of properties, and a plurality of investment related parameters of the plurality of properties;
removing the plurality of properties that do not meet a preliminary criterion from an acquisition pipeline through the one or more applications or algorithms a primary filter that is run on the hardware processor, and wherein the plurality of criteria comprises legal, crime rating, liability, and liveability, criteria of the plurality of properties;
loading a ranking engine comprising an artificial intelligence (AI) model on the hardware processor and run on the hardware processor to execute the instruction stored on a memory to receive and analyse the plurality of collected data on the plurality of properties to provide a ranking based investment score for a property under evaluation or consideration;
running a web-based platform stored with a web-based application to compliment the investment score provided by the AI model to enable analysts to evaluate and provide a final ranking-based investment score for the property under valuation, and wherein the final ranking score is used to retain the AI model;
wherein the final ranking-based investment score comprises two components, and wherein the final ranking-based investment score is a weighted sum of proximity score, market score and financial score, and wherein the final ranking-based investment score is obtained mathematically using an equation, the final ranking-based investment score = 0.25 ∗ Proximity Score + 0.25 ∗ Market Score + 0.5 ∗ Financial Score;
wherein the proximity score comprises downtown score, restaurant score, airport score, attraction score, and store score, and wherein the market score comprises walk score, population density score, crime score, house appreciation score, job prospect score, weather score, air quality score, and water quality score, and wherein the final investment ranking score is simply a weighted sum of financial score, proximity score and market score, and wherein the brain score is mathematically represented as:
$$\begin{matrix}\text{Brain Score = 0} \text{.25 * proximity score + 0} \text{.25 * market score +} \\ \text{0} \text{.5 * Financial Score,}\end{matrix}$$
and wherein the proximity score is calculated using the equation:
$$\begin{matrix}p r o x i m i t y \_ s c o r e = 0.1 \times d o w n t o w n \_ s c o r e + 0.1 \times \\ r e s t a u r a n t \_ s c o r e + 0.3 \times a i r p o r t \_ s c o r e + 0.3 \times \\ s t o r e \_ s c o r e + 0.1 \times a t t r a c t i o n \_ s c o r e \text{;} \text{and}\end{matrix}$$
wherein the market score is calculated mathematically as follows:
$$\begin{matrix}M a r k e t \_ s c o r e = 0.1 \times w a l k \_ s c o r e + 0.05 \times \\ p o p u l a t i o n \_ d e n s i t y \_ s c o r e + 0.1 \times c r i m e \_ s c o r e + 0.2 \times \\ h o u s e \_ a p p r e c i a t i o n \_ s c o r e + 0.1 \times j o b \_ p r o s p e c t \_ s c o r e + \\ 0.1 \times w e a t h e r \_ s c o r e + 0.05 \times a i r \_ q u a l i t y \_ s c o r e + 0.05 \times \\ w a t e r \_ q u a l i t y \_ s c o r e\end{matrix}$$
.

16. The method according to claim 15, wherein the plurality of location-based parameters comprises full address of the property, and wherein the address includes name of the city in which the property is located, state, zip code, latitude, and longitude of the property.

17. The method according to claim 15, wherein the plurality of physical parameters or data comprises a type of property and amenities provided in the property, and wherein the amenities include maximum number of guests accommodated in the property, number of bath rooms and a number of bedrooms provided in the property, and wherein a furnishing price of the property is calculated based on the number of bedrooms and number of bathrooms.

18. The method according to claim 15, wherein AI model is configured to perform a cohort analysis on the plurality of location-based parameters including full address data, zip code, the latitude and longitude coordinates, and the physical parameters to obtain an output, and wherein the output of the cohort analysis is subjected to a time series analysis to compute an expected month-wise ADR and an expected month-wise reservation days to compute an expected yearly revenue for the property.

19. The method according to claim 15, wherein the investment related features of the property comprise listed price of the property on market, the number of days on market with the listed price, and the last known price on the market, and the current status of the property, and wherein a purchase price of the property is calculated based on the listed price of price of the property on market, the number of days on market with the listed price, and the last known price on the market, and wherein a property tax and the utility tax are calculated based on the computed purchase price of the property, and wherein a closing coat and the total utility cost are calculated based on the computed purchase value and computed furnishing cost.

20. The method according to claim 15, wherein a plurality of derived parameters is calculated based on the collected investment related parameters, and wherein the derived parameters include an insurance cost and the HOA fees for the property.

21. The method according to claim 15, wherein a property management cost, and a repair and maintenance cost are calculated based on the estimated expected yearly revenue of the property.

22. The method according to claim 15, wherein an operating expense for the property is calculated based on the computed property management cost, the computed repair and maintenance cost, the computed property tax, the computed utility tax, the computed insurance cost and the computed HOA fees for the property.

23. The method according to claim 15, wherein a net operating income is calculated based on the estimated expected yearly revenue of the property and the computed operating expenses of the property.

24. The method according to claim 15, wherein a cap rate for the property is calculated based on the computed net operating income and the total utility cost of the property, and wherein a financial score of the property is calculated based on the computed cap rate for the property.

25. The method according to claim 15, wherein the collected location-based data and the collected physical parameter data of the property under consideration are filtered using a filtering module to find short term rentals of the property similar to the property under consideration, and wherein the parameters used for filtering comprises latitude and longitude coordinates, Zip code, number of bed rooms, and number of bath rooms, maximum number of guests to be accommodated, and type of property, and amenities provided in the property for the property under consideration, and wherein the property under consideration is ignored and ranked of least interest or ranking, when the number of computations obtained based on the search criteria is less than 12, and wherein the number of filtering criteria is reduced until at least a dozen computations are obtained, and wherein a dozen computations are obtained, when the number of filtering criteria is greater than 4, and wherein the number of filtering criteria is equal to or less than 4, a search for the property in a broader vicinity is conducted, and wherein, at least a dozen properties with their monthly Revenue, ADR, occupancy rates, and reservation days are obtained after the completion of cohort analysis.

26. The method according to claim 15, wherein a time-series analysis is performed on the computed data to develop an AI model to estimate monthly ADR, occupancy rates, revenue, and reservation days of the property under consideration for the future.

27. The method according to claim 15, wherein the cap rate for the property is calculated using the AI algorithm which is executed on a hardware processor in the system, and wherein the steps of calculating the cap rate comprises:
Input property_tax_percentage, utility_percentage, closing_cost_percentage, property_management_percentage, repair_and_maintainance_percentage values;
Calculate the annual value using the following mathematical equation:
Calculate the property tax using the following mathematical equation:
Calculate the utility value using the following mathematical equation:
Calculate the property management cost using the following mathematical equation:
Calculate the repair and maintenance cost of the property using the following mathematical equation:
Calculate the operating expenses cost of the property using the following mathematical equation:
Calculate the net operating income of the property using the following mathematical equation:
Calculate the closing cost of the property using the following mathematical equation:
Calculate the total utility value of the property using the following mathematical equation:
Calculate the cap rate for the property using the following mathematical equation:
.

28. The method according to claim 15, wherein a financial score for the property is assigned based on the computed caprate value using an algorithm, and wherein the financial score is calculated using the algorithm as given below:
If cap_rate < 5: then the Financial_Score = 4 ∗ cap_rate;
If 5 < cap_rate < 16: then the Financial Score = 0.0017x5 - 0.0926x4+2.0435x3-23.1037x2+142.5287x - 317.7937;
If cap_rate > 16: then the Financial Score = 100.
